(19) United States
(12) Patent Application Publication
(10) Pub. No.: US 2002/0000100 A1
(43) Pub. Date: Jan. 3, 2002

(54) METHOD AND DEVICE FOR WASTE RECYCLING IN A MINERAL FIBRE MANUFACTURING PLANT

(76) Inventors: DANIEL BURG, LA CHATRE (FR); GIOVANNI COLPANI, DI LOMBARDIA (IT)

Correspondence Address: OBLON SPIVAK MCCLELLAND, MAIER & NEUSTADT, 1755 JEFFERSON DAVIS HIGHWAY, FOURTH FLOOR, ARLINGTON, VA, 22202

(21) Appl. No.: 09/147,589

(22) PCT Filed: May 19, 1998
(86) PCT No.: PCT/FR98/00996

(30) Foreign Application Priority Data
May 28, 1997 (IT) MI97A001255

(51) Int. Cl. C03B 3/00; C03B 7/02; C03B 5/173

(52) U.S. Cl. 65/134.3; 65/134.8

(57) ABSTRACT

The invention relates to the technology of manufacturing mineral fibres, glass wool or rock wool and, more specifically, to the recycling of scrap in the manufacturing plants.

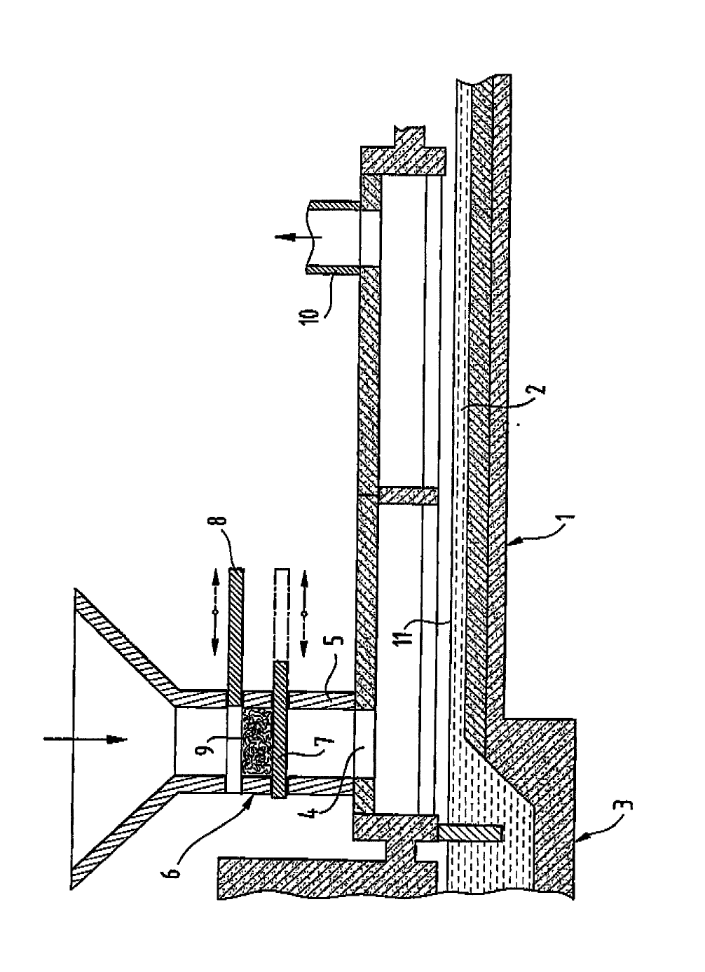

The scrap, reduced to fragments, is introduced into the delivery channel through which the molten glassy material passes before reaching the fiberizing machine.

The device of the invention includes a pressure-isolating feed system.

Large quantities of scrap may be introduced without disturbing the manufacture of the mineral wool.

The invention relates to the technology of manufacturing mineral fibres and, more specifically, to the recycling of scrap in manufacturing plants.

In the modern world, the concerns of industries to be able to operate in an environmentally friendly manner are encouraging research on finding, by any means, ways of recycling all kinds of scrap. Thus, each industry seeks to recycle not only its own scrap but also, in general, any scrap, of whatever origin.

The mineral-fibre industry, especially that producing various types of wool intended mainly for insulation, i.e. glass wool or rock wool, produces scrap at the various manufacturing steps. It is important to be able to recycle this scrap by means of an operation which may be called “self-recycling”. However, it may also be advantageous to recycle scrap from other sources, and even some which does not contain any mineral fibre at all. This recycling may then be called “heterorecycling”.

Wool mats intended mainly for insulation are produced on an industrial scale by a two-step process which involves, firstly, producing the actual fibres, by drawing and freezing a molten glassy material, and then combining a very large number of fibres which are joined together to form a mat. Between the two steps, the glass or rock fibres are sprayed with a binder which will be polymerized by the end of the second step. Once the mat has been completed, there remain the finishing operations to be carried out in order to form a product ready to use. In particular, the longitudinal edges of the ribbon must be cropped so that they are sharper. This operation produces scrap—the edges of the mat, which it is desired to reuse. Likewise, some trimmings, resulting from the subsequent use of panels or rolls, constitute by-products which it would be advantageous to be able to recycle. These are, for example, panels with various facings, glass cloth, Kraft paper, plastic films, etc. These panels have not been regarded as meeting the required quality and have been rejected at the end-of-the-line inspection, or have even been returned by unsatisfied customers.

There are various techniques for recycling the scrap from various sources in the manufacture of rock wool. These techniques are distinguished by the moment in the manufacture when the scrap is introduced.

Mineral-wool manufacturing processes may be divided into two groups—the production of glass wool and the production of so-called “rock” wool. In the first process, the batch (or raw materials) which constitutes a glass composition, essentially a mixture of oxides, is heated in a furnace under well controlled conditions and then the molten glassy material is led to a centrifuging machine, for example that described in Patent EP-B-0,091,866, where the individual fibres are generated. The processing of the molten glassy material intended for the production of rock wool is generally carried out in a completely different manner. The batch (various types of rock, such as basalt, or blast-furnace slag) is introduced simultaneously with a fuel (coal) via the top of a cupola furnace. As the batch drops down, it melts and becomes homogeneous. The molten glassy material is collected at the bottom. This material is led to a fiberizing machine such as that known as an “external centrifuging” machine described, for example, in Patent Application EP-A-0,059,152. This machine also generates individual mineral fibres.

The method most widely used for reintroducing scrap is employed at the moment when the individual fibres are brought together in order to be combined by means of a resin and to form a mat. In the second process mentioned above, which in general uses a single source of fibres, the trimmings are in the form of flakes which are injected into the reception hopper, the flakes being sucked down at the same time as the new fibres on the conveyor which is a perforated belt where the first mat forms. In the other process, which uses several fibre-generating units in series, two techniques have been employed, namely introducing the trimmings in the form of flakes either above the conveyor, between two fibre-generating heads, or, according to the technique described in Patent FR 2,559,793, directly into one or more of the reception hoppers.

The amount of material to be recycled that can be reintroduced into the reception hoppers of a mineral-wool production line may vary; in particular, it depends on the respective densities of the products manufactured and the product to be recycled. It also depends on the market for which the product under manufacture is intended. Be that as it may, the amounts which can be introduced are too small to absorb all the scrap which it would be desirable to recycle, even if only for those based on mineral fibres.

Another technique employed for recycling scrap consists in reintroducing it with the batch. The techniques differ depending on whether a glass furnace (for glass wool) or a cupola furnace (for rock wool) is involved. In the first case, the scrap is introduced as it is together with the batch. The furnace is generally an electric furnace whose surface is entirely covered with the pulverulent batch. Patent Application FR 2,199,856 proposes, inter alia, compensating for the reducing effect due to the combustion of the organic matter by adding sulphates or nitrates. It is known in fact that adding mineral wool with its binder to a bath of molten glassy material significantly disrupts production of the glass. Foaming and skinning may occur, which are very problematic and disrupt the fiberizing operation.

U.S. Pat. No. 4,422,862 proposes depositing the glass scrap on the surface of the batch so that the gases from the furnace burn off the binders. This cunning technique is not very reliable as the coverage of the pulverulent batch is not uniform and at a point where the coverage is thin, or a fortiori where the coverage is absent, the scrap drops immediately into the furnace with the aforementioned drawbacks—an uncontrollable disturbance of the delicate chemistry occurring during the production of the glass is observed. Moreover, when the coverage of the batch is thick, it significantly insulates the scrap which is deposited thereon and there is no guarantee that the binders are burnt off.

In the cupola furnaces used for producing the molten glassy material intended for the production of rock wool, it is usual to introduce the pulverulent batch by first of all agglomerating it into the form of briquettes. This technique is also used for recycling pulverulent scrap recovered from the flue gases leaving the cupola furnace and it is also used for recycling scrap based on mineral fibres. The technique of manufacturing briquettes is quite expensive and it is attempted to limit the use thereof to the cases in which it is the only technique available. It would be advantageous to use a technique which would allow direct recycling of the scrap without having to require an additional intermediate operation such as the manufacture of briquettes.

There is one final technique for recycling fibrous scrap, which has something in common with reintroducing it together with the batch, namely the so-called OXYMELT technique. This consists in using residues based on mineral fibres to make a glass therefrom, which glass will be added to the batch as if it were ordinary cullet. The binder and other organic residues in the scrap are burnt off in oxygen and then the fibrous material is melted using a burner. After cooling, the glass obtained may be added to the other batch materials and recycled, The energy balance of this operation is not favourable as only a cold glass is obtained, which has to be remelted.

In the manufacture of rock wool using a cupola furnace, there is also a method of recycling scrap during the production of the glass. This involves reintroducing the scrap into a burner at the base of the cupola furnace. It is at this point that the oxidizer gas is introduced, this gas being combined with the carbon to provide the heat which will melt the rocks. Patent Application ER-A-0,611,212 describes such a method, in which the scrap reduced to powder is introduced, simply under gravity, into a duct which connects the “blast box” of the cupola furnace to the inside of the latter. However, this very effective method requires preparation of the scrap since it must be reduced to very small fragments in order to be easily entrained in narrow pipes.

The aim of the invention is to substitute the above scrap-recycling methods with a simpler technique which is more economic and which allows large quantities of scrap to be recycled.

The invention provides a process for the recycling of scrap in a plant for producing mineral wool obtained using a technique of fiberizing a molten glassy material in a plant comprising at least one channel for delivering the said glassy material, in which process the scrap consists of volatile or combustible material or material having a melting point at most equal to that of the mineral wool, in which the scrap constitutes fragments and in which the latter are introduced into the delivery channel.

The process of the invention provides, anywhere there is a transfer of the molten glassy material between its production site (blast furnace or cupola furnace) and the fiberizing machine, an elegant solution to the problem of recycling scrap, especially scrap based on mineral wool.

Preferably, the scrap is introduced into the channel in a zone where the temperature of the glassy material is at least 1000° C.

Likewise, the maximum size of the fragments of scrap is 10 cm and, advantageously, the proportion by weight of recycled scrap is about 4%.

It will be seen that the conditions for implementing the invention are very advantageous and easy to realize.

The invention also provides a device for implementing the process of the invention, which includes a hopper fitted in the upstream part of the channel, which hopper is equipped with a pressure-isolating feed system.

In one embodiment, the feed system uses the scrap itself as the pressure-isolating means and, in another embodiment, the feed system includes a lock, especially one equipped with dampers.

Advantageously, the device of the invention includes a chimney fitted onto the channel.

It will be seen that the components of the device are particularly simple, inexpensive and easy to employ.

The single FIGURE and the description will allow the operation of the invention to be understood and all its advantages to be appreciated.

The FIGURE shows, diagrammatically, the feeder of a glass furnace intended, in particular, for the manufacture of mineral fibres.

The present description refers to a furnace which forms part of a plant for the production of mineral wool obtained using a technique of fiberizing a molten raw material (or batch)—in fact such a plant produces, immediately during the manufacture of the mats or subsequently during their use, scrap which contains mineral fibres to be recycled—but a glass furnace, with a feeder, intended for example for the manufacture of bottles could likewise be equipped with the device of the invention for implementing the process.

The feeder 1 in the FIGURE which is also called a delivery channel, is intended to convey the molten glassy material 2 from the furnace 3, where the batch is melted and the glass produced, to the forming machines such as fiberizing machines where the end-product, in particular the fibrous mat, is formed.

In the delivery channel, the temperature of the molten glassy material is not everywhere the same. In the production of glass wool, the temperature at the head of the channel is greater than 1200° C. and, downstream, it is generally about 200° C. lower. In order to maintain these temperatures, depending on the plant and on the pull, it may be necessary to supply thermal energy, possibly via a flame but in general by the Joule effect using electrodes immersed in the molten glass.

In order to undertake scrap-recycling trials, the delivery channel was modified. Upstream, near the furnace exit, a 50×50 cm opening 4 was created in the crown of the channel above the surface 11 of the molten glass 2. In the first place, this opening was simply extended by a vertical duct 5, made of refractory bricks, which remained open and constituted a kind of hopper.

It is by passing via the duct 5 that scrap, mainly mineral-fibre scrap, under various conditions, was introduced.

First of all, the trial began by introducing fragments torn off from glass-wool mats of the TELSTAR type—an ISOVER SAINT-GOBAIN product. The greatest dimension of these fragments was, at most, about 10 cm. The first trial to introduce the fragments into the channel, by making them pass via the duct 5, failed—a strong upflow of hot gases prevented the fragments from dropping down.

In the second trial, the fragments, identical to the previous ones, were moistened with water before they were introduced via the opening 4. This time, the ballasted fragments were not repelled. By observing their behaviour through peepholes made in the walls of the channel, it was observed that as the fragments approach the bath of glass, they burst into flame, that they floated on the bath while continuing to burn and that they gradually disappeared, becoming diluted in the molten bath. Despite this influx of foreign matter, the operation of fiberizing the glass was carried out naturally, without any disturbance, using the TEL technique (identical to that in Patent EP-B-0,091,866).

A second trial took place after modifying the charging device. A lock was made at the inlet of the hopper in order to form a pressure-isolating feed system. The lock 6 is fitted into the duct 5 and is bounded by the walls of the latter and by two superposed dampers 7, 8 which may close the opening. The principle of the device is always to have one of the dampers, 7 or 8, closed. A charge of scrap 9 is therefore introduced in a discontinuous manner.

The operations are performed in the following manner: with the lower damper 7 closed, fragments of scrap are introduced on top of the lower damper 7 in order to form a charge 9. The upper damper 8 is then closed and, by opening the lower damper 7, the charge is discharged.

By virtue of this device, any upflow of gas is prevented and it becomes possible to introduce all the scrap, whatever its density.

The above device made it possible to introduce scrap of any kind and thus to allow systematic trials to be carried out. It was observed that:

it is possible to “digest” very different kinds of scrap;

a dry or wet scrap is absorbed in the same way; and

large amounts may be assimilated without disturbing the downstream part of the line, i.e. without noticing it at the fiberizing point. In particular, the oxido-reduction problems observed when the scrap was introduced into the bath of glass near the furnace do not exist here.

At the end of the trials, two modifications were made to the plant. A chimney, on the one hand, and a bubbler, on the other hand, were fitted.

The chimney, shown diagrammatically at 10 in the FIGURE, has the function of removing the gases produced by the heating and/or combustion of the organic matter contained in the scrap and, especially, the binders or sizes on the mineral fibres. The chimney, made conventionally of refractory bricks, terminates in a plant for treating the flue gases. The latter, when they are harmless, are then released into the atmosphere.

The other accessory fitted to the delivery channel has proved to be useful when using wet scrap. This is because it has been found that wet scrap drops more quickly into the bath of glass and thus modifies the stream of molten glass. By collecting all the glass at the end of the channel, it has been found that, when wet scrap has been fed into it, the glass instead of being very homogeneous is veined: it has regions of different refractive index. These heterogeneities may lead to variations in the quality of the individual glass fibres making up the mat. The homogeneity of the bath of glass could be re-established by using a bubbler (not illustrated in the FIGURE). This is a tube made of refractory metal, for example platinum, which dips into the bath of glass, from the top down, gas being blown in through this tube. The bubbling produces movements throughout the mass of liquid glass, homogenizing it.

In the case of mineral-wool scrap, the use of the bubbler is generally necessary only if the scrap is wet.

Another system for introducing scrap, different from the lock shown in the FIGURE with its two dampers 7, 8, has been used. This was an Archimedean screw having a horizontal axis. This device is one of those mentioned in the document EP-A-0,611,212. This document presents techniques in which it is the products to be introduced which themselves act as pressure-isolating means, that is to say that it is these which, as a compact mass, constitute a plug which maintains the pressure difference between the two, upstream and downstream, environments. The Archimedean screw, with its axis approximately horizontal, is entirely applicable for fibrous scrap. It is more difficult to use the vertical device with vibrator, also described in EP-A-0,611,212, because of the low density of the fragments to be introduced.

The device of the invention, including its various alternative forms, which has just been described has been used to determine the limits of the process of the invention.

Firstly, the nature of the products recycled was varied, these being essentially glass wool, rock wool, both being obtained by centrifuging, or glass cloth the fibres of which come from spinerets and which is also structured by a binder. All these products can be easily recycled by the process of the invention.

Next, the amount of fibrous scrap introduced (self-recycling) was increased. It was possible to achieve, and even exceed, for long periods (several hours) scrap levels of 4%, that is to say that, on a channel outputting quantities of molten glass of between 80 and 85 tonnes per day, glass-wool scrap was introduced at levels of 140 kg/hour on a continuous basis. No disturbance in the quality of the glass wool obtained was observed. During these trials, the scrap was fragments torn from TELSTAR glass-wool mats. Their composition was 93% glass and 7% organic binder.

The limit of the process is due to the amount of glass “to be digested”. That is to say that, even if the scrap is wet, for example, the limit is that of the amount of glass to be integrated into the molten glass. The water contained in the product has no effect on the limit.

The plant described above has made it possible to carry out energy balances. These are useful in order to be able, depending on the nature of the scrap introduced, to adjust the heat supplied to the feeder in order always to have a glass output at the same temperature.

The organic matter, essentially the binder, contained in the mineral-wool scrap supplies, during its combustion, heat to the medium. On the other hand, energy must be supplied in order to melt the glass of the fibres and raise it to the temperature of the molten glass in the feeder. On the other hand, the water must be heated and then vaporized. Calculations, together with their verification during the trials, have shown that the balance is neutral for dry glass wool—neither supply nor consumption of energy; it is positive in the case of glass cloth which supplies more energy than it consumes (800 kWh/t of scrap) but, on the other hand, wet glass wool consumes energy (about 100 kWh per tonne of scrap).

The economics of reintroduction of rock-wool or glass-cloth scrap into the delivery channel are very advantageous when compared with the other techniques. We have seen here that the energy balance is either neutral or highly positive or, possibly, slightly negative. The other costs are either identical to those of the other methods (shredding and handling) or non-existent.

The economics are comparable only in the method of reintroduction, in reception, of the individual fibres. The method of reintroduction into the batch requires, as was mentioned, compensating for the supply of reducing agent (the binder) by an oxidizing agent, such as a sulphate or a nitrate, which is not cost-free.

In the case of cupola furnaces, the manufacture of the briquettes is an expensive operation which is often carried out elsewhere than on the production site.

The OXYMELT technique provides, as product, a cold glass, and it is necessary to expend heat in order to reheat and melt it.

The above description was centred around a glass furnace with a feeder leading to fiberizing machines such as those in the TEL process described, in particular, in Patent EP-B-0,091,866, but all of the above applies equally well to mineral-wool manufacturing techniques such as, for example, those which use a cupola furnace and external centrifuging of rock wool, as described in particular in Patent EP-B-0,059,152, simply insofar as the molten glass passes through a channel before reaching the fiberizing machine. Such a channel is described, for example, in Patent Application FR 2,572,390.

1. Process for the recycling of scrap in a plant for producing mineral wool obtained by the technique of fiberizing a molten glassy material in a plant which includes at least one channel for delivering the said glassy material, characterized in that the scrap consists of volatile or combustible materials or materials having a melting point at most equal to that of the mineral wool, in that it consists of fragments and in that the latter are introduced into the delivery channel.

2. Process according to claim 1, characterized in that the scrap is based on mineral wool.

3. Process according to claim 1 or claim 2, characterized in that the scrap is introduced into the channel in a zone where the temperature of the glassy material is at least 1000° C.

4. Process according to one of the preceding claims, characterized in that the maximum size of the fragments of scrap is 10 cm.

5. Process according to one of the preceding claims, characterized in that the proportion by weight of recycled scrap is about 4%.

6. Device for the implementation of the process according to one of the preceding claims, characterized in that it includes a hopper fitted into the upstream part of the channel and in that it is equipped with a pressure-isolating feed system.

7. Device according to claim 6, characterized in that it includes a chimney fitted onto the channel.

8. Device according to claim 6 or claim 7, characterized in that the feed system includes a lock equipped, in particular, with dampers.

9. Device according to claim 6 or claim 7, characterized in that the feed system uses the scrap itself to act as pressure-isolating means.

10. Device according to one of claims 6 to 9, characterized in that it is equipped with at least one bubbler.
